(19) United States
(12) Patent Application Publication
(10) Pub. No.: US 2023/0302629 A1
(43) Pub. Date: Sep. 28, 2023

(54) ROBOTIC SYSTEM CONTROL METHOD AND ROBOTIC SYSTEM

(71) Applicant: SEIKO EPSON CORPORATION, Tokyo (JP)

(72) Inventor: Koji YOSHII, SHIOJIRI-SHI (JP)

(21) Appl. No.: 18/125,747

(22) Filed: Mar. 24, 2023

(30) Foreign Application Priority Data
Mar. 25, 2022 (JP) 2022-049470

(51) Int. Cl. B25J 9/00; B25J 9/16

(52) U.S. Cl. CPC B25J 9/0096; B25J 9/1684; B25J 9/163

(57) ABSTRACT

A control method for a robotic system includes the robotic system having a transportation device that transports an object and a robot that performs work while following the object being transported by the transportation device, the method makes the robot follow the object by a control signal calculated based on a transport speed of the object detected from an output signal of an encoder located on the transportation device, and changes a calculation method of the control signal when the transport speed exceeds a threshold.

The present application is based on, and claims priority from JP Application Serial Number 2022-049470, filed Mar. 25, 2022, the disclosure of which is hereby incorporated by reference herein in its entirety.

### BACKGROUND

### 1. Technical Field

The present disclosure relates to a robotic system control method and a robotic system.

### 2. Related Art

In the related art, there has been known a robotic system that performs following work on objects that are transported by a transportation device, such as a conveyor belt. In such a robotic system, the transport speed of an object is detected based on an encoder value of the conveyor belt, and the drive of the robot is controlled based on the detection result. With respect to this type of configuration, JP-A-2007-290128 describes obtaining a virtual encoder value based on the encoder value of the conveyor belt to reduce the effects of noise and vibration, and detecting transport speed of the object based on this virtual encoder value. Further, JP-A-2007-290128 calculates the virtual encoder value using past encoder values and filter functions, and sets a parameter of the filter functions according to the magnitude of vibration.

However, in the disclosure in JP-A-2007-290128, the robot may not be able to follow changes in the transport speed of the conveyor belt during the work.

### SUMMARY

A robotic system control method according to this disclosure is for a robotic system including a transportation device that transports an object and a robot that performs work while following the object being transported by the transportation device, the robotic system control method including: making the robot follow the object by a control signal calculated based on a transport speed of the object detected from an output signal of an encoder that is located in the transportation device and changing the calculation method of the control signal when the transport speed exceeds a threshold value.

The robotic system according to this disclosure includes: a transportation device that transports an object; a robot that performs work while following the object being transported by the transportation device; and a control device which controls the drive of the robot, wherein: the control device makes the robot follow the object by a control signal calculated based on a transport speed of the object detected from an output signal of an encoder located in the transportation device, and changes the calculation method of the control signal when the transport speed exceeds a threshold value.

### BRIEF DESCRIPTION OF THE DRAWINGS

FIG. 1 is an overall configuration diagram of a robotic system according to a first embodiment.

FIG. 2 is a graph showing a deviation D between output signal P1 and smoothed signal P2.

FIG. 3 is a block diagram of a filter circuit included in a control device.

FIG. 4 is a graph for explaining a threshold value setting method.

FIG. 5 is a graph for explaining a robotic system control method.

FIG. 6 is a flowchart for explaining the robotic system control method.

FIG. 7 is a diagram showing an example of a graphic interface.

FIG. 8 is a graph showing threshold values set in the robotic system according to a second embodiment.

FIG. 9 is a block diagram of a filter circuit included in the control device.

FIG. 10 is a graph showing threshold values set in the robotic system according to the second embodiment.

### DESCRIPTION OF EMBODIMENTS

Hereinafter, a robotic system control method, and the robotic system according to the present disclosure will be described in detail based on embodiments shown in the accompanying drawings.

### First Embodiment

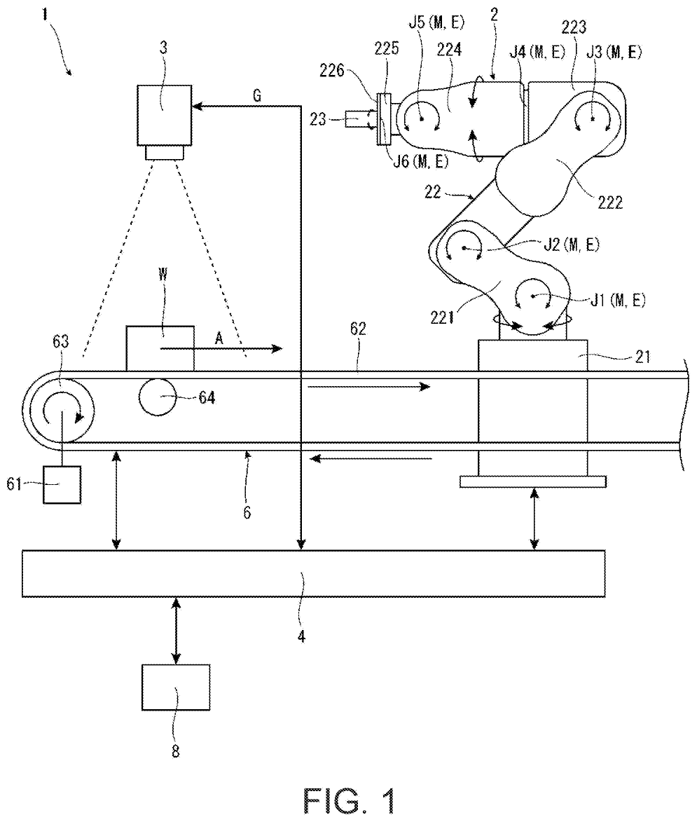

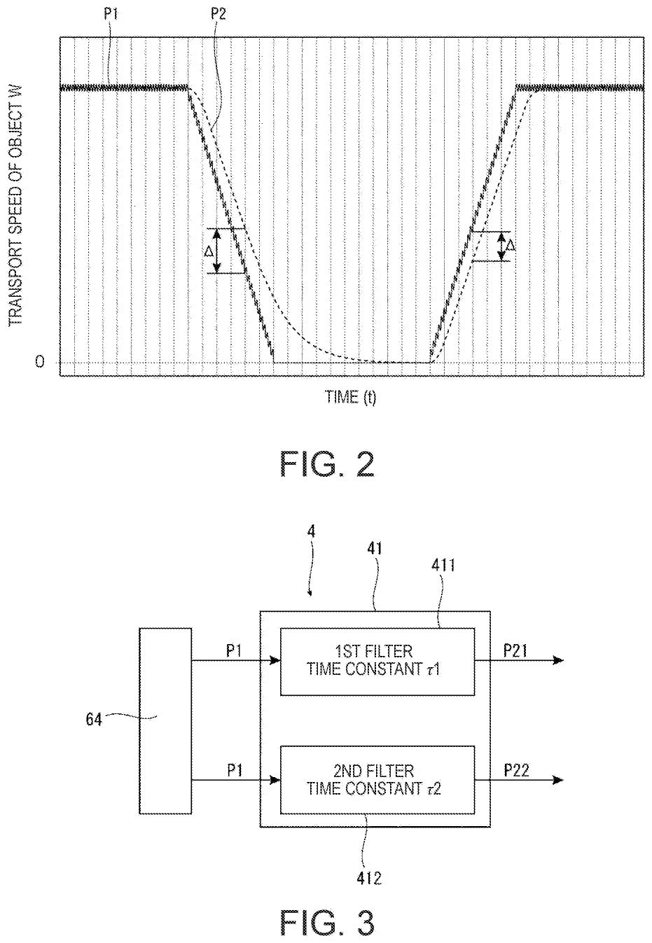

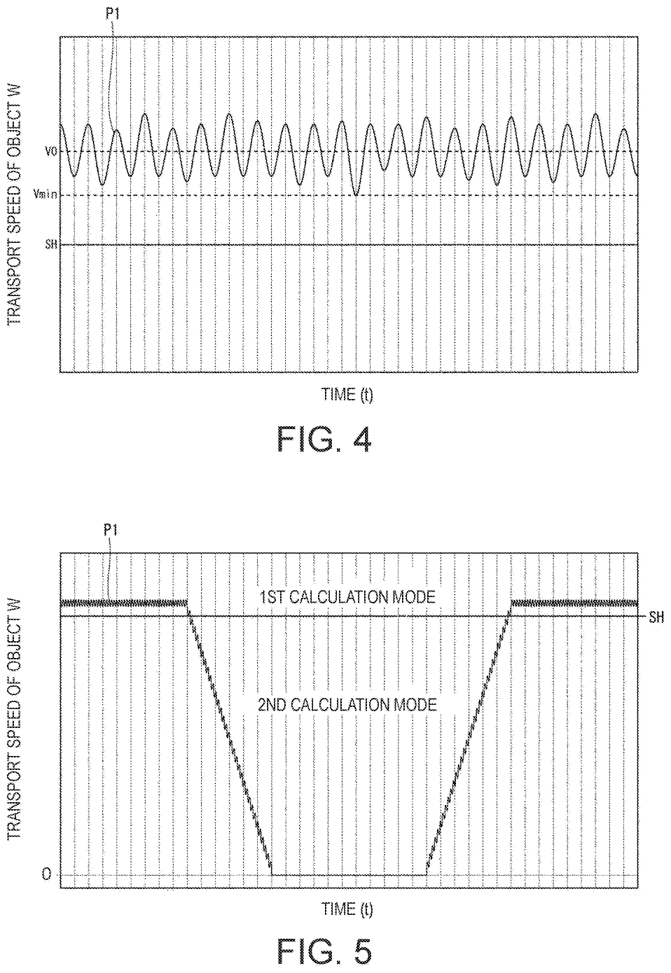

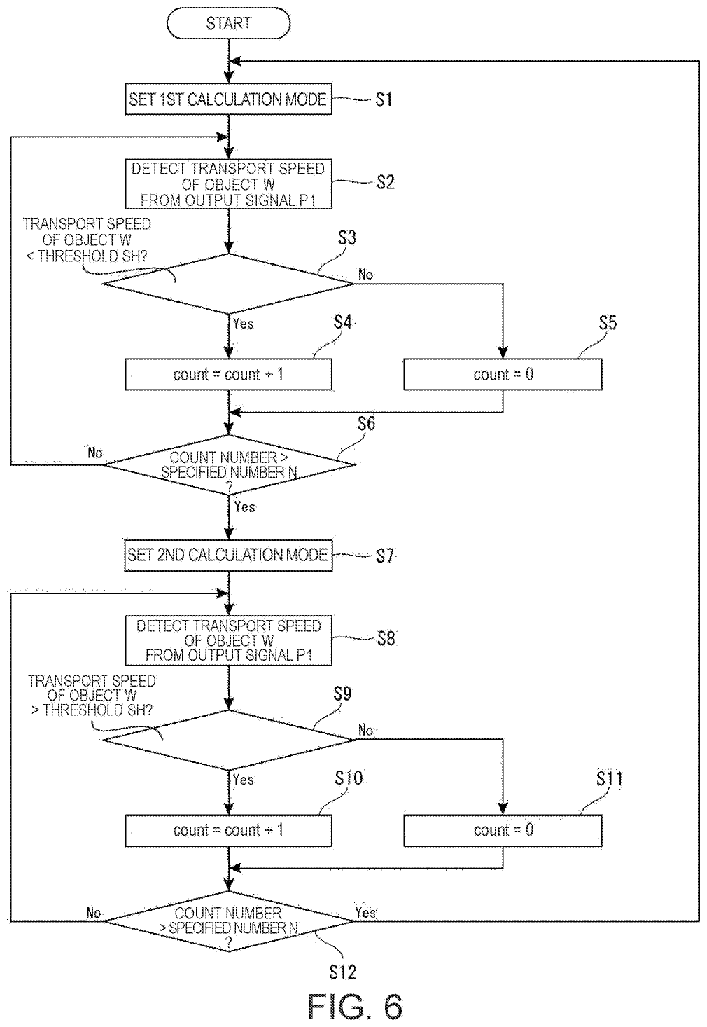

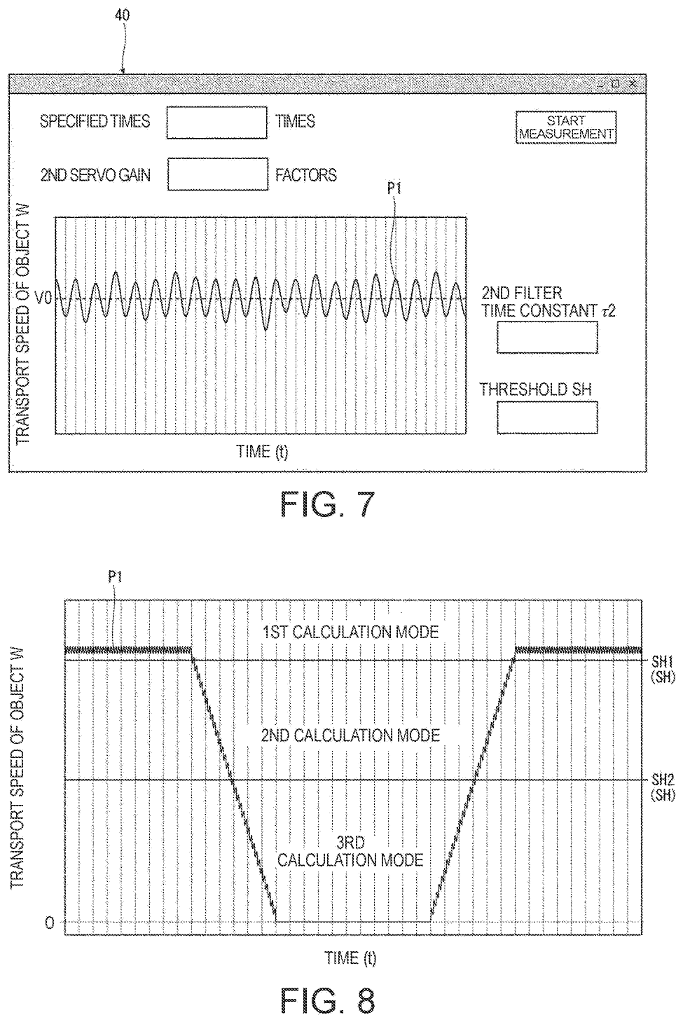

FIG. 1 is an overall configuration diagram of a robotic system according to a first embodiment. FIG. 2 is a graph showing a deviation D between output signal P1 and smoothed signal P2. FIG. 3 is a block diagram of a filter circuit included in a control device. FIG. 4 is a graph for explaining a threshold value setting method. FIG. 5 is a graph for explaining a robotic system control method. FIG. 6 is a flowchart for explaining the robotic system control method. FIG. 7 is a diagram showing an example of a graphic interface.

The robotic system 1 shown in FIG. 1 includes a robot 2, an imaging section 3, a control device 4, a transportation device 6, and a display device 8. In the robotic system 1, the transportation device 6 transports an object W along a transport direction A, the control device 4 detects a transport state of the object W based on an image G acquired by the imaging section 3 and a transport speed of the object W, and the robot 2 performs work while following the object W during transportation. The work to be performed on the object W is not particularly limited, and includes, for example, drilling, connection with another member (insertion, screwing, engaging the screw, or the like), cleaning, and inspection. In addition, the object W is not limited to any particular object, for example, industrial products such as printers or automobiles or their parts, or any other object that can be worked on by the robot 2.

As shown in FIG. 1, the robot 2 is a 6-axis vertical articulated robot having six drive axes, and has a base 21, a robot arm 22 that is rotatably connected to the base 21, and an end effector 23 attached to a tip of the robot arm 22. Further, the robot arm 22 is a robotic arm with a plurality of arms 221, 222, 223, 224, 225, and 226 that are rotatably connected, and has six joints J1 through J6. Among them, the joints J2, J3, and J5 are bending joints, and the joints J1, J4, and J6 are torsional joints. The end effector 23 is selected as appropriate for the desired work.

In addition, a motor M, and an encoder E that detects a rotation amount are installed in each of the joints J1, J2, J3, J4, J5, and J6. During operations of the robotic system 1, the control device 4 executes servo control (feedback control) for each joint J1 to J6 so that the rotation angle of joints J1 to J6 indicated by the output of the encoder E matches a target position, which is a control target.

The transportation device 6 is a conveyor belt, and includes a belt 62, a transportation roller 63 that feeds the belt 62, a motor 61 that drives the transportation roller 63, and an encoder 64 that outputs a signal corresponding to a rotation amount of the belt 62 to the control device 4. During operations of the robotic system 1, the control device 4 executes servo control (feedback control) that matches the transport speed of the object W indicated by the output of the encoder 64 with the target transport speed, which is the control target.

The imaging section 3 is a camera that captures an image of the object W from above the transportation device 6 and outputs the captured image to the control device 4. The imaging area of the imaging section 3 is located upstream of a work area of the robot 2 in the transport direction A. The imaging section 3 has an angle of view that includes the object W being transported on the belt 62. A position in the image that is output from the imaging section 3 is associated with a position in the transportation path by the control device 4. Therefore, when the object W exists within the angle of view of the imaging section 3, coordinates of the object W at the time the image is captured can be identified based on the position of the object W in the image of the imaging section 3.

The control device 4 controls a drive each of the robot 2, the imaging section 3, and the transportation device 6. The control device 4 is, for example, configured from a computer, and has a processor (CPU) that processes information, a memory that is communicatively connected to the processor, and an external interface that connects to external devices. Various programs executable by the processor are stored in the memory, and the processor can read and execute the various programs stored in the memory. Some or all of the components of the control device 4 may be located inside the housing of the robot 2. Further, the control device 4 may be configured by a plurality of processors.

The above is a brief description of the configuration of the robotic system 1. Such a robotic system 1 operates as follows. First, the control device 4 operates the transportation device 6 and controls the drive of the transportation device 6 so that the transport speed of the object W, which is, detected based on the output of the encoder 64, becomes the target transport speed. In this state, the object W is supplied to the transportation device 6, and the transport of the object W by the transportation device 6 begins. Next, the control device 4 uses the imaging section 3 to capture the object W passing through the imaging area, and acquires an image G in which the object W appears. Next, from the image G, the control device 4 detects the coordinates of the object W at the time when the image G was acquired. Next, the control device 4 calculates the position of the object W at future times based on the coordinates of the object W at the time when the image G was acquired and on the transport speed of the object W, and calculates a control signal for the robot 2 based on the calculated position. The control device 4 then drives the robot 2 with the calculated control signal and causes the robot 2 to perform a predetermined work while following the object W being transported.

Here, the transportation roller 63 provided on the transportation device 6 is designed in a true cylindrical shape to transport the belt 62 smoothly, but depending on the accuracy of its formation, the overall shape of the transportation roller 63 may deviate from a true cylindrical shape. Further, even if the transportation roller 63 is formed in a true cylindrical shape, the rotation shaft may shift from the center axis and become eccentric. If the shape of the transportation roller 63 deviates from the true cylindrical shape or the transportation roller 63 is eccentric, high-frequency noise caused by them will be carried on the output signal of the encoder 64. In addition, if the shape of the transportation roller 63 deviates from the true cylindrical shape, periodic irregularities in the transport speed of the object W will occur.

Therefore, if the control signal is calculated using the transport speed of the object W detected from the output signal of the encoder 64, the motion of the robot 2 may be disturbed due to the aforementioned high-frequency noise or uneven speed. So, for example, it is conceivable that the output signal of the encoder 64 be smoothed by a filter circuit in the control device 4, and the transport speed of the object W be detected from the smoothed signal output from the filter circuit. In this way, by smoothing the output signal of the encoder 64 with the filter circuit, the effects of the high-frequency noise and uneven speed as described above can be suppressed, and the operation of the robot 2 stabilized.

While this is an advantage, depending on the filter time constant T set in the filter circuit, when the transport speed of the object W changes precipitously, as when the transportation device 6 is temporarily stopped and restarted, then, as shown in FIG. 2, the waveform of the smoothed signal P2 becomes dull compared to the waveform of the output signal P1 of the encoder 64. As a result, a deviation Δ arises between the output signal P1 and the smoothing signal P2. Therefore, if the control signal is calculated from the transport speed of the object W detected from the smoothed signal, when the transport speed of the object W changes precipitously, the robot 2 will be misaligned with respect to the object W being transported due to the deviation Δ, and work on object W cannot be performed properly. In other words, even if it has a filter circuit, if there is only one calculation method of the control signal, it cannot respond to precipitous changes in the transport speed of the object W.

Therefore, the robotic system 1 has multiple calculation methods for the control signal and changes the calculation method of the control signal when the transport speed of the object W exceeds a threshold value SH, thereby reducing the positional deviation of the robot 2 from the object W compared to the calculation method before the change. According to this method, even if the transport speed of the object W changes precipitously, the positional deviation of the robot 2 with respect to the object W during transport is suppressed, and appropriate work can be performed on the object W. In this specification, the transport speed of the object W exceeds the threshold value SH means that the transport speed of the object W exceeds or falls below the threshold value SH. The following is a specific description.

As shown in FIG. 3, the control device 4 has a first filter circuit 411 and a second filter circuit 412 as a filter circuit 41. The first filter circuit 411 and the second filter circuit 412 are band rejection filter circuits that each cut a predetermined frequency component, in this embodiment, a high-frequency component above the predetermined frequency. However, the first filter circuit 411 and the second filter circuit 412 may be bandpass filters. In this case, they may be set to pass frequency components below a predetermined frequency.

The first filter circuit 411 smooths the output signal P1 of the encoder 64 and outputs a smoothed signal P21. Similarly, the second filter circuit 412 smooths the output signal P1 of the encoder 64 and outputs a smoothed signal P22. The first filter time constant τ1 set in the first filter circuit 411 and the second filter time constant τ2 set in the second filter circuit 412 are different from each other, and in this embodiment, the first filter time constant τ1 is larger than the second filter time constant 12. In other words, the first filter circuit 411 has a lower cutoff frequency fc than the second filter circuit 412.

Therefore, the smoothed signal P21 is superior to the smoothed signal P22 in removing high-frequency noise, but has a larger deviation Δ when the transport speed of the object W changes precipitously. On the other hand, the smoothed signal P22 is inferior to the smoothed signal P21 in removing high-frequency noise, but it is more responsive and has a smaller deviation Δ when the transport speed of the object W changes precipitously.

The control device 4 has a first calculation mode in which the control signal of the robot 2 is calculated using the smoothed signal P21 and a second calculation mode in which the control signal of the robot 2 is calculated using the smoothed signal P22. The control device 4 compares the transport speed of the object W detected from the output signal P1 of the encoder 64 with the threshold value SH for the transport speed stored in the memory, and selects one of the first calculation mode and the second calculation mode based on the comparison result.

The threshold value SH is set lower than the target transport speed V0 of the object W, taking into account an amplitude of the high-frequency noise. For example, in the teaching operation, the transportation device 6 is driven at the target transport speed V0, and, as shown in FIG. 4, the output signal P1 of the encoder 64 is measured at that time. This output signal P1 contains high-frequency noise caused by the shape deviation or eccentricity of the transportation roller 63, and the transport speed of the object W fluctuates periodically. Next, the minimum speed Vmin is detected from the output signal P1. The threshold value SH is then set to a value lower than the minimum speed Vmin. The threshold value SH is not limited as long as it is lower than the minimum speed Vmin, but is desirably as high as possible in a range lower than the minimum speed Vmin.

As shown in FIG. 5, when the transport speed of the object W detected from the output signal P1 is equal to or higher than the threshold value SH, the transport speed of the object W is stable near the target transport speed V0, and the deviation Δ is hardly generated. Therefore, the control device 4 selects the first calculation mode in which the control signal of the robot 2 is calculated by using the smoothed signal P21, which has a high noise removal effect. On the other hand, when the transport speed of the object W detected from the output signal P1 is lower than the threshold value SH, the transport speed of the object W may be changing precipitously, and the deviation Δ is likely to occur. Therefore, the control device 4 selects the second calculation mode in which the control signal of the robot 2 is calculated by using the smoothed signal P22, which has a small deviation Δ.

According to this method, the deviation Δ can be kept small when the transport speed of the object W changes precipitously, compared to the case where the control signal is always calculated in the first calculation mode. Therefore, the deviation between the transport speed of the object W and the following speed of the robot 2 can be suppressed. As a result, the positional deviation of the robot 2 with respect to the object W being transported is suppressed, and appropriate work can be performed on the object W. In particular, such a method makes it easy to change the method of calculating the control signal, since all that is required is switch the filter time constant.

By setting the threshold SH to be lower than the minimum speed Vmin, it is possible to avoid frequent switching between the first and second calculation modes in unnecessary situations (where the object W is being transported at the target transport speed V0) due to the high-frequency noise, and the control signal of the robot 2 can be calculated stably.

Here, an example of how to switch between the first and second calculation modes is explained based on a flowchart of FIG. 6. First, as step S1 the control device 4 sets the calculation mode of the control signal to the first calculation mode. Next, as step S2, the control device 4 detects the transport speed of the object W from the output signal P1. Next, in step S3, the control device 4 determines whether the transport speed of the object W detected in step S2 is less than the threshold value SH. If the transport speed of the object W is lower than the threshold value SH, the control device 4 adds+1 to the count number as step S4. On the other hand, when the transport speed of the object W is equal to or higher than the threshold value SH, the control device 4 does not count the count number as step S5. Next, as step S6, the control device 4 determines whether the count number has reached a specified number of times N, which is specified in advance. If the count number has not reached the specified number of times N, it returns to step S2. If the count number has reached the specified number of times N, the control device 4 switches the calculation mode of the control signal from the first calculation mode to the second calculation mode as step S7.

Next, as step S8, the control device 4 detects the transport speed of the object W from the output signal P1. Next, in step S9, the control device 4 determines whether the transport speed of the object W detected in step S8 is equal to or higher than the threshold value SH. If the transport speed of the object W is equal to or higher than the threshold value SH, the control device 4 adds+1 to the count number as step S10. On the other hand if the transport speed of the object W is lower than the threshold value SH, the control device 4 does not count the count number as step S11. Next, as step 512, the control device 4 determines whether the count number has reached the specified number of times N specified in advance. If the count number has not reached the specified number of times N, it returns to step S8. If the count number has reached the specified number of times N, it returns to step S1 and switches the calculation mode of the control signal from the second calculation mode to the first calculation mode.

Depending on the characteristics of the transportation device 6 and the environment in which it is used, there is a possibility that sudden large noise may occur in the output signal P1. The aforementioned specified number of times N is set so that the calculation mode is not switched by such a sudden change of the transport speed.

Further, as described above, the control device 4 servo-controls each joint J1 to J6 of the robot 2. Specifically, for each joint J1 to J6, the control device 4 outputs a velocity command by performing position loop control based on a position feedback signal from the encoder E and a position command, outputs an acceleration command by performing velocity loop control based on the velocity command and a velocity feedback signal from the encoder E, generates the control signal, as a current command, based on the acceleration command, and drives each motor M by the generated control signal.

Therefore, the control device 4 changes a servo gain that is set by the servo control according to the transport speed of the object W. The servo gain is a parameter that determines responsiveness and stability of operation. The higher the servo gain, the better the responsiveness, but too high a servo gain may cause vibration. The servo gain includes a position loop gain in the position loop control and a velocity loop gain in the velocity loop control, and one or both of these values can be changed.

The control device 4 has a first servo gain and a second servo gain that are used to calculate the control signal of the robot 2. The second servo gain is higher than the first servo gain. When the transport speed of the object W detected from the output signal P1 is equal to or higher than the threshold value SH, that is, when in the first calculation mode, the transport speed of the object W is stable near the target transport speed V0, and the positional deviation of the robot 2, which is caused by a servo delay, with respect to the object W being transported is less likely to occur. Therefore, the control device 4 calculates the control signal of the robot 2 by using the first servo gain with high damping property. On the other hand, when the transport speed of the object W detected from the output signal P1 is less than the threshold value SH, that is, when in the second calculation mode, there is a possibility that the transport speed of the object W is changing precipitously, and a positional deviation of the robot 2, which is caused by servo delay, with respect to the object W being transported is likely to occur. Therefore, the control device 4 calculates the control signal of the robot 2 by using the second servo gain with high responsiveness.

According to this method, the servo delay when the transport speed of the object W changes precipitously can be suppressed, compared to the case where the control signal is always calculated in the first calculation mode. Therefore, the deviation between the transport speed of the object W and the following speed of the robot 2 can be suppressed. As a result, the positional deviation of the robot 2 with respect to the object W being transported is suppressed, and appropriate work can be performed on the object W. In particular, according to this method, the calculation method of the control signal can be easily changed by simply switching the servo gain.

Here, when changing the filter time constant or the servo gain, sudden acceleration/deceleration may occur in the control signal of the robot 2. If this acceleration/deceleration exceeds the maximum allowable value set for the robot 2, the robot 2 may automatically stop due to an error. Therefore, it is desirable to set the first and second filter time constants τ1 and τ2 and the first and second servo gains so that the acceleration/deceleration that occurs during the change does not exceed the maximum allowable value. It is also desirable to limit the control signal or compensate the control signal so that acceleration/deceleration which exceeds the maximum allowable value does not occur.

The control device 4 can display a graphic interface 40 as shown in FIG. 7 on the display device 8 and accept input from the user via the graphic interface 40. The graphic interface 40 displays the output signal P1 of the encoder 64 obtained during the teaching operation and the columns for setting the second filter time constant τ2, the threshold value SH, the specified number of times N, and the second servo gain. The user can freely determine each of the second filter time constant τ2, the threshold value SH, the specified number of times N, and the second servo gain, based on the displayed output signal P1. However, this is not limited to this, and each of these parameters may be set automatically by the control device 4 based on information obtained from the teaching operation (characteristics of the transportation device 6) and the like.

The robotic system 1 has been described above. The control method for this type of robotic system 1 is, as described above, a control method for the robot system 1 having the transportation device 6 that transports the object W and the robot 2 that performs work while following the object W transported by the transportation device 6, and the control method includes making the robot 2 follow the object W by the control signal calculated based on the transport speed of the object W detected from the output signal of the encoder 64 that is located in the transportation device6 and changing the calculation method of the control signal when the transport speed exceeds the threshold value SH. According to this method, the deviation Δ when the transport speed of the object W changes precipitously can be suppressed to be small. Therefore, the positional deviation of the robot 2 with respect to the object W being transported is suppressed, and appropriate work can be performed on the object W.

Further, as described above, in the control method for the robotic system 1, the control signal is calculated by the filter circuit 41 that processes the output signal of the encoder 64, and when the transport speed of the object W exceeds the threshold value SH, the calculation method is changed by changing the filter time constant of the filter circuit 41. According to this method, the calculation method of the control signal can be changed in a simple method.

Also, as described above, in the control method for the robotic system 1, the first filter time constant τ1, which is the filter time constant when the transport speed of the object W is equal to or greater than the threshold value SH, is larger than the second filter time constant τ2, which is the filter time constant when the transport speed of the object W is less than the threshold value SH. According to this, it is possible to more reliably suppress the deviation Δ to be small when the transport speed of the object W changes precipitously.

As described above, the control method for the robotic system 1 servo controls the robot 2, and when the transport speed of the object W exceeds the threshold value SH, the calculating method of the control signal of the robot 2 is changed by changing the servo gain of the servo control. According to this method, the calculation method of the control signal can be changed in a simple method.

In addition, as described above, in the control method for the robotic system 1, the first servo gain, which is the servo gain when the transport speed of the object W is less than the threshold value SH, is greater than the second servo gain, which is the servo gain when the transport speed of the object W is equal to or larger than the threshold value SH. According to this, it is possible to more reliably suppress the deviation Δ to be small when the transport speed of the object W changes precipitously.

Further, as described above, the robotic system 1 has the transportation device 6 that transports the object W, the robot 2 that performs work while following the object W being transported by the transportation device 6, and the control device 4 that controls the drive of the robot 2. Then, the control device 4 makes the robot 2 follow the object W by the control signal calculated based on the transport speed of the object W detected from the output signal of the encoder 64 that is located in the transportation device 6, and changes the calculation method of the control signal when the transport speed of the object W exceeds a threshold value SH. According to this configuration, it is possible to suppress the deviation Δ when the transport speed of the object W changes precipitously. Therefore, the positional deviation of the robot 2 with respect to the object W being transported is suppressed, and appropriate work can be performed on the object W.

### Second Embodiment

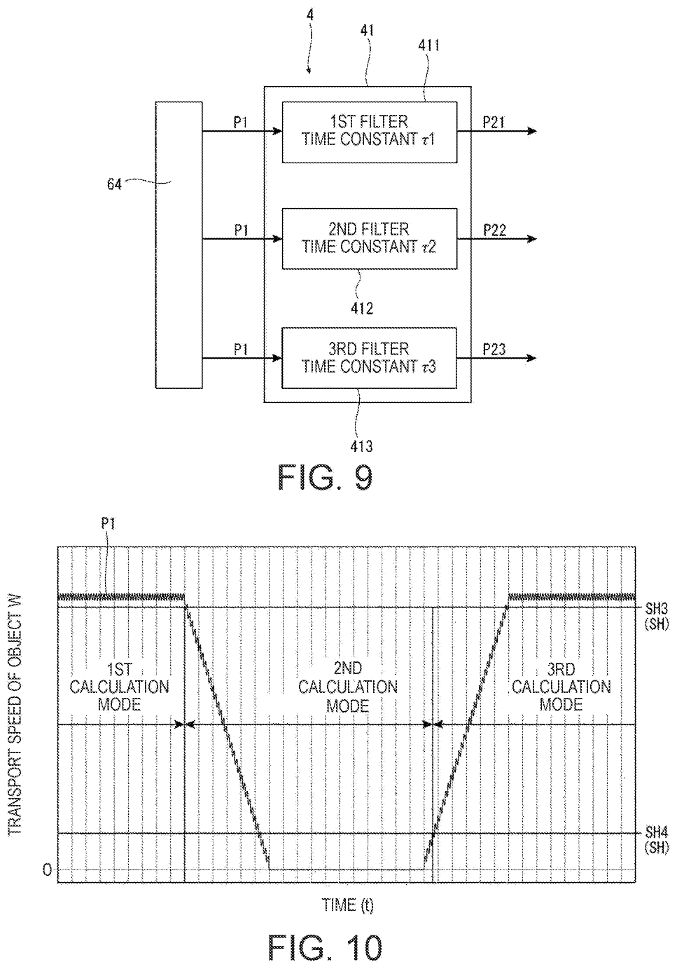

FIG. 8 is a graph showing threshold values set in the robotic system according to a second embodiment. FIG. 9 is a block diagram of a filter circuit included in the control device.

The robotic system 1 of this embodiment is similar to the robotic system 1 of the first embodiment described above, except that the method of setting the threshold value SH is different. Therefore, in the following description, this embodiment will be described with a focus on differences from the first embodiment described above, and description of similar matters will be omitted. In each figure in this embodiment, the same symbols are used for the same configurations as in the above described embodiment.

In the robotic system 1 in this embodiment, as shown in FIG. 8, a plurality of threshold values SH are set. Specifically, a first threshold value SH1 and a second threshold value SH2, which is lower than the first threshold value SH1, are set as the threshold values SH.

As shown in FIG. 9, the control device 4 has a first filter circuit 411, a second filter circuit 412, and a third filter circuit 413 as the filter circuit 41. The first, second and third filter circuits 411, 412, and 413 smooth the output signal P1 of the encoder 64 and output smoothed signals P21, P22, and P23, respectively. Further, a first filter time constant τ1 set in the first filter circuit 411, a second filter time constant τ2 set in the second filter circuit 412, and a third filter time constant τ3 set in the third filter circuit 413 are different from each other. In this embodiment, the first filter time constant τ1>the second filter time constant τ2, and the first filter time constant τ1>the third filter time constant τ3. The relationship between the second filter time constant τ2 and the third filter time constant τ3 is not particularly limited.

When the transport speed of the object W detected from the output signal P1 is equal to or higher than the first threshold value SH1, the transport speed of the object W is stable and deviation Δ is unlikely to occur. Therefore, the control device 4 selects the first calculation mode in which the control signal of the robot 2 is calculated by using the smoothed signal P21, which has a high noise removal effect. When the transport speed of the object W detected from the signal P1 is equal to or higher than the second reference value SH2 and below the first threshold value SH1, the transport speed of the object W may be changing precipitously, and deviation Δ is likely to occur. Therefore, the control device 4 selects the second calculation mode in which the control signal of the robot 2 is calculated by using the smoothed signal P22, which has a small deviation Δ. In addition, when the transport speed of the object W detected from the signal P1 is less than the second threshold value SH2, the transport speed of the object W may be changing precipitously, and the deviation Δ is likely to occur. Therefore, the control device 4 selects the third calculation mode in which the control signal of the robot 2 is calculated by using the smoothed signal P23 with a small deviation Δ.

In this way, by setting a plurality of threshold values SH, the acceleration/deceleration regions of the object W can be subdivided and the optimum filter time constant can be set for each region. Therefore, it is possible to suppress the deviation Δ when the transport speed of the object W changes precipitously. Therefore, the positional deviation of the robot 2 with respect to the object W being transported is suppressed, and appropriate work can be performed on the object W.

As described above, in the control method for the robotic system 1 according to this embodiment, a plurality of threshold values SH are set. In this way, by setting a plurality of threshold values SH, the acceleration/deceleration regions of the object W can be subdivided and the optimum filter time constant can be set for each region. Therefore, it is possible to suppress the deviation when the transport speed of the object W changes precipitously. Therefore, the positional deviation of the robot 2 with respect to the object W being transported is suppressed, and appropriate work can be performed on the object W.

Such a second embodiment can also achieve the same effects as the aforementioned the first embodiment.

### Third Embodiment

FIG. 10 is a graph showing thresholds set in the robotic system according to a third embodiment.

The robotic system 1 of this embodiment is similar to the robotic system 1 of the first embodiment described above, except that the method of setting the threshold value SH is different. Therefore, in the following description, this embodiment will be described with a focus on differences from the first embodiment described above, and description of similar matters will be omitted. In the figures of this embodiment, the same symbols are used for the same configurations as in the above described embodiments.

In the robotic system 1 of this embodiment, as shown in FIG. 10, a plurality of threshold values SH are set. Specifically, a deceleration threshold value SH3, which is adopted when the transport speed of the object W decreases, and an acceleration threshold value SH4, which is adopted when the transport speed of the object W increases, are set as the threshold value SH. Further, the acceleration threshold value SH4 is lower than the deceleration threshold value SH3.

When the transport speed of the object W detected from the output signal P1 decreases from higher than or equal to the deceleration threshold value SH3 to below the deceleration threshold value SH3, the control device 4 switches the calculation method of the control signal from the first calculation mode to the second calculation mode. On the other hand, when the transport speed of the object W detected from the output signal P1 increases from below the acceleration threshold value SH4 to higher than or equal to the acceleration threshold value SH4, the control device 4 switches the calculation mode of the control signal from the second calculation mode to the first calculation mode. In this way, the threshold values SH for switching between the first calculation mode and the second calculation mode are different when the transport speed of the object W decreases and when it increases. As a result, deviation Δ can be suppressed to a small amount in both cases of precipitous decrease and increase of the transport speed of the object W. Therefore, the positional deviation of the robot 2 with respect to the object W being transported is suppressed, and appropriate work can be performed on the object W.

As described above, in the control method for the robotic system 1 of this embodiment, the plurality of set threshold values SH includes the deceleration threshold value SH3 to be adopted when the transport speed of the object W decreases and the acceleration threshold value SH4 to be adopted when the transport speed of the object W increases. Accordingly, the deviation Δ can be suppressed to small in both cases where the transport speed of the object W precipitously decreases and increases. Therefore, the positional deviation of the robot 2 with respect to the object W being transported is suppressed, and appropriate work can be performed on the object W.

Such a third embodiment can also achieve the same effects as aforementioned the first embodiment.

The above description of the robotic system control method and the robotic system of this disclosure is based on the embodiment shown in the figures. However, the disclosure is not limited to this, and configuration of each part can be replaced with any configuration having similar functions. In addition, other arbitrary components may be added to this disclosure. Further, the each embodiments may be appropriately combined.

What is claimed is:

1. A robotic system control method for a robotic system including a transportation device that transports an object and a robot that performs work while following the object being transported by the transportation device,
the robotic system control method comprising:
making the robot follow the object by a control signal calculated based on a transport speed of the object detected from an output signal of an encoder that is located in the transportation device; and
changing the calculation method of the control signal when the transport speed exceeds a threshold value.

2. The robotic system control method according to claim 1, wherein
the control signal is calculated by using a filter circuit that processes the output signal of the encoder, and
when the transport speed exceeds the threshold value, the calculation method is changed by changing a filter time constant of the filter circuit.

3. The robotic system control method according to claim 2, wherein
the filter time constant, when the transport speed is equal to or higher than the threshold value, is larger than the filter time constant when the transport, speed is less than the threshold value.

4. The robotic system control method according to claim 1, wherein
a plurality of threshold values are set.

5. The robotic system control method according to claim 4, wherein
the plurality of threshold values include a deceleration threshold value used when the transport speed decreases and an acceleration threshold value used when the transport speed increases.

6. The robotic system control method according to claim 1, wherein
the robot is controlled by servo control, and
when the transport speed exceeds the threshold value, the calculation method of the control signal is changed by changing servo gain of the servo control.

7. The robotic system control method according to claim 6, wherein
the servo gain, when the transport speed is less than the threshold value, is larger than the servo gain when the transport speed is equal to or higher than the threshold value.

8. A robotic system comprising:
a transportation device that transports an object;
a robot that performs work while following the object being transported by the transportation device; and
a control device that controls the drive of the robot, wherein
the control device makes the robot follow the object by a control signal calculated based on a transport speed of the object detected from an output signal of an encoder located in the transportation device, and
changes the calculation method of the control signal when the transport speed exceeds a threshold value.
